(19) United States
(12) Patent Application Publication
(10) Pub. No.: US 2026/0355704 A1
(43) Pub. Date: Nov. 12, 2026

(54) Apparatus and Method for Producing Nanobubbles

(71) Applicant: Trident Material Technologies, Ltd., London (GB)

(72) Inventor: Ahmadi Hossein, Istanbul (TR)

(73) Assignee: Trident Material Technologies, Ltd., London, EN (GB)

(21) Appl. No.: 19/488,658

(22) PCT Filed: Jun. 3, 2024
(86) PCT No.: PCT/EP2024/065173

§ 371 Date: Nov. 28, 2025

(30) Foreign Application Priority Data
Jun. 2, 2023 (EP) 23177090.0

(51) Int. Cl. B01F 25/314; B01F 23/23; B01F 23/232; B01F 23/2375; B01F 25/00

(52) U.S. Cl. CPC B01F 25/31421; B01F 23/232; B01F 23/2375; B01F 23/238; B01F 25/3143; B01F 2025/916; B01F 2025/9321

(57) ABSTRACT

Apparatus for making nanobubbles, comprises:
a liquid lumen through which liquid flows in use, defined by one or more sidewalls, a liquid inlet and a liquid outlet, the one or more sidewalls being made of or comprising gas-permeable material;
a gas lumen though which or into which gas flows in use, defined by the one or more sidewalls of the liquid lumen, one or more further sidewalls, one or more gas inlets and, optionally, a gas outlet;
wherein in use gas introduced into the gas lumen passes through the gas-permeable material of the one or more sidewalls and into liquid flowing in the liquid lumen as nanobubbles; and
wherein the cross-sectional diameter of the liquid lumen decreases in the direction of flow from the liquid inlet to the liquid outlet.

### INTRODUCTION

The present invention relates to an apparatus and method for producing liquid compositions containing ultrafine bubbles, also referred to as nanobubbles. The invention also relates to applications and uses of the compositions.

### BACKGROUND TO THE INVENTION

An ultrafine bubble, or nanobubble, is a bubble that has a diameter of less than one micron (see further definitions thereof within). For context, a microbubble, which is larger than a nanobubble, is a bubble that has a diameter greater than or equal to one micron and smaller than 50 microns. A macrobubble is a bubble that has a diameter greater than or equal to 50 microns.

Nanobubbles have several unique properties such as long lifetime in liquid due to their negatively charged surfaces and buoyancy in liquids. Nanobubbles also have high gas solubility into their surrounding liquid due to their high internal pressure. Conversely, micro-and macro-bubbles are larger in size, and thus rise rapidly and burst at the water surface, losing their gas to the surrounding atmosphere. Nanobubbles are applicable in a variety of fields and can have numerous beneficial effects from a medical, industrial and agricultural point of view.

To date several methods of generating nanobubbles have been proposed. These methods include using swirl-type liquid flow, high-pressure dissolution, ejector, mixed vapor direct contact condensation and supersonic vibration. All of these methods are, however, inefficient, energy intensive and produce nanobubbles at low concentrations.

U.S. Pat. No. 10,598,447 describes an apparatus for producing a composition of nanobubbles dispersed in a liquid carrier. The apparatus comprises an interior cavity which receives the liquid and a permeable member within the cavity which receives the gas, wherein the permeable member has a porous side wall. One problem with this apparatus is that the resulting nanobubbles are often large and therefore unstable, meaning that they don't remain in the liquid carrier for long.

US 2020/0289992 describes another apparatus for producing nanobubbles in a volume of liquid. The apparatus comprises a motor which has a rotatable shaft, an axially rotatable permeable member coupled to a gas inlet and a rotatable tube support coupled to the rotatable shaft of the motor. This apparatus can produce nanobubbles, but is energy intensive.

US 2021/0299617 describes another apparatus for producing nanobubbles, comprising a conduit through which a liquid carrier flows and a gas diffuser configured to receive gas from a gas source.

WO 2018/090143 describes another apparatus for generating gas bubbles. The apparatus comprises a liquid lumen in the centre and a gas lumen surrounding the liquid lumen. There is a diffuser, at least a portion of which is porous, disposed between the liquid lumen and the gas lumen. Creating nanobubbles is again very energy intensive as it requires both the liquid and gas to be kept at high pressures or flow rates.

It is desirable to make nanobubbles more efficiently and having defined properties such as consistent and reduced size.

An aim of the present invention is to provide an alternative apparatus and method for nanobubble manufacture, and in embodiments to provide an improved apparatus and method that addresses one or more problems identified, especially for efficiently forming high concentrations of nanobubbles.

### SUMMARY OF THE INVENTION

Apparatus of the invention, for making nanobubbles, comprises:
a liquid lumen through which liquid flows in use, defined by one or more sidewalls, a liquid inlet and a liquid outlet, the one or more sidewalls being made of or comprising gas-permeable material;
a gas lumen though which or into which gas flows in use, defined by the one or more sidewalls of the liquid lumen, one or more further sidewalls, one or more gas inlets and, optionally, a gas outlet;
wherein in use gas introduced into the gas lumen passes through the gas-permeable material of the one or more sidewalls and into liquid flowing in the liquid lumen as nanobubbles; and
wherein the cross-sectional area of the liquid lumen decreases in the direction of flow from the liquid inlet to the liquid outlet.

In operation, a change in the pressure in respectively the liquid and gas lumens along their lengths promotes nanobubble formation by the apparatus. In particular, the change in pressure differential between the liquid and gas lumens along their lengths is suitably a net increase.

A second apparatus of the invention for making nanobubbles, comprises:
a liquid lumen through which liquid flows in use, defined by one or more sidewalls, a liquid inlet and a liquid outlet, the one or more sidewalls being made of or comprising gas-permeable material;
a gas lumen though which or into which gas flows in use, defined by the one or more sidewalls of the liquid lumen, one or more further sidewalls, one or more gas inlets and, optionally, a gas outlet;
wherein in use gas introduced into the gas lumen passes through the gas-permeable material of the one or more sidewalls and into liquid flowing in the liquid lumen as nanobubbles; and
wherein the one or more sidewalls of the liquid lumen comprise one or more magnets located or otherwise incorporated therein to promote nanobubble formation.

In operation, nanobubble formation and/or stability is enhanced by flowing the nanobubble-containing liquid past the magnets.

A method according to the invention for making nanobubbles, comprises
introducing liquid into a liquid lumen, said lumen defined by one or more sidewalls, a liquid inlet and a liquid outlet, the one or more sidewalls being made of or comprising gas-permeable material;
introducing gas into a gas lumen, said lumen defined by the one or more sidewalls of the liquid lumen, one or more further sidewalls, one or more gas inlets and, optionally, a gas outlet, so that the gas introduced into the gas lumen passes through the gas-permeable material and into the liquid, forming nanobubbles; and
decreasing the pressure of the liquid as it flows along the length of the liquid lumen.

A second method according to the invention for making nanobubbles, comprises
introducing liquid into a liquid lumen, said lumen defined by one or more sidewalls, a liquid inlet and a liquid outlet, the one or more sidewalls being made of or comprising gas-permeable material, the liquid optionally comprising infused gas;
introducing gas into a gas lumen, said lumen defined by the one or more sidewalls of the liquid lumen, one or more further sidewalls, one or more gas inlets and, optionally, a gas outlet, so that the gas introduced into the gas lumen passes through the gas-permeable material and into the liquid, forming nanobubbles; and
flowing the nanobubbles and/or the infused gas past one or more magnets in the one or more sidewalls of the liquid lumen.

The methods are suitably carried out using apparatus of the invention as defined herein.

### DETAILED DESCRIPTION OF THE INVENTION

There is thus provided apparatus for making nanobubbles, comprising:
a liquid lumen, defined by one or more sidewalls, a liquid inlet and a liquid outlet, the one or more sidewalls being made of or comprising gas-permeable material;
a gas lumen, defined by the one or more sidewalls of the liquid lumen, one or more further sidewalls, one or more gas inlets and, optionally, one or more gas outlets;
wherein gas introduced into the gas lumen passes through the gas-permeable material of the one or more sidewalls and into liquid flowing in the liquid lumen as nanobubbles; and
wherein (a) the cross-sectional area of the liquid lumen decreases in the direction of flow from the liquid inlet to the liquid outlet, or (b) the one or more sidewalls of the liquid lumen comprise one or more magnets located or otherwise incorporated therein to promote nanobubble formation and wherein the cross-sectional diameter of the liquid lumen preferably decreases in the direction of flow from the liquid inlet to the liquid outlet.

Gas in the gas lumen is at pressure and liquid in the liquid lumen is at pressure, and the respective pressures vary along the length of the apparatus. In embodiments of the invention, there is a pressure differential between the gas in the gas lumen and liquid in the liquid lumen and the differential increases along the length of the apparatus in the direction of liquid flow. Higher pressure in the gas lumen urges nanobubbles into the liquid.

Apparatus of the invention are suitably adapted such that the pressure of gas in the gas lumen increases in the direction of flow and/or the pressure of liquid in the liquid lumen decreases in the direction of liquid flow.

The pressure differential between gas in the gas lumen and liquid in the liquid lumen is preferably greatest at an end of the apparatus which is closest to the liquid output.

During operation of the apparatus liquid flows through the liquid lumen from the inlet towards the outlet and at the same time gas is pumped or drawn into the gas lumen via the gas inlet(s). Gas passes through the gas-permeable sidewall(s) and hence the pump provides/maintains gas at pressure in the gas lumen. The liquid and gas lumens share one or more sidewalls, and gas passes through pores in the sidewall(s) and emerges into the liquid in the form of nanobubbles.

In use, the nanobubble making apparatus has been found efficiently to produce nanobubbles in high concentrations.

The apparatus suitably may also include one or more pumps or pump devices to deliver gas and/or liquid under at least atmospheric pressure. For example, there may be a pump connected to the liquid inlet to pump liquid into the liquid lumen and a pump connected to the gas inlet(s) to deliver gas into the gas lumen. This ensures that a gas pressure sufficient for gas to pass through the sidewall of the liquid lumen is maintained for nanobubbles to be formed in the liquid. Optionally, there may also be a pump to deliver liquid into the gas lumen; hence, both gas and liquid are pumped into the gas lumen at the same time. This has the effect of further increasing the pressure in the gas lumen, thus increasing the pressure differential between the liquid lumen and the gas lumen and promoting movement of gas into the liquid lumen. A liquid composition exiting the apparatus via the liquid outlet can be collected in a container or flow into a further conduit for processing or collection.

The apparatus and related method described below are for forming nanobubbles in a wide variety of liquids and the scope in general is not intended to be limited to any liquids in particular. Exemplary liquids include water, aqueous solutions, sea water, polluted water, sterilizing solutions, carbonated solutions e.g. carbonated water and cell and tissue culture solutions. Other exemplary liquids include alcohols, solutions containing one or more alcohols and mixtures thereof. Other exemplary liquids include cooling liquids and heating liquids. Still other exemplary liquids include hydrocarbons, solutions of hydrocarbons, oils, waste oil, crude oil, drilling fluids and mining fluids. Typical methods introduce nanobubbles into water and aqueous solutions.

Similarly, the apparatus, and related method described below are for forming nanobubbles of a wide variety of gases and the scope in general is not intended to be limited to any gas in particular. Exemplary gases include one or more, or mixtures of two or more of air, oxygen, ozone, nitrogen, carbon dioxide and hydrogen, or other gases. Typical methods introduce nanobubbles of air and/or oxygen, especially into water and aqueous solutions.

The gas permeable material is suitably conventional and is available in various known forms, and described in the noted prior art. It is typically inert to the gas and liquid and porous to the gas being introduced into the liquid in the form of nanobubbles. The material suitably comprises pores of size 500 nm or less, preferably 300 nm or less or 200 nm or less. Material used in specific examples had pore sizes in the range 10 nm-100 nm. In other embodiments, the material comprises pore sizes in the range 1-10 nm. As will be appreciated, pore size in combination with operating parameters of the apparatus can be varied to tailor nanobubble sizes and applications. Suitable measures for measuring pore size include X-ray diffraction and mercury intrusion porosimetry.

The gas permeable material may vary along the whole length of the apparatus. The gas permeable material may also be liquid permeable. Specifically, there may be two or more sections of different porous materials along of the length of the apparatus. For example, there may be two or three sections, optionally each having different pore sizes. In a first section, at or towards the first end of the apparatus, where liquid enters the liquid lumen, the pores may be dimensioned such that liquid can pass out of the liquid lumen into the gas lumen. In a second and/or third section, at or towards the second end of the apparatus, the pores may be dimensioned such that gas (and optionally also liquid) can pass out of the gas lumen into the liquid lumen. The pores may be granulated or smooth or a mixture of both.

The process of producing nanobubbles using an apparatus of the invention may therefore be a two-stage process, where liquid is introduced to the gas lumen in a first section, and is mixed with gas throughout, but is pushed back through the permeable membrane in the second section, along with gas, into the liquid lumen. The effect of this is that pressure builds up in the gas lumen whilst the liquid pressure in the liquid lumen is reducing, helping to push the liquid, along with gas, back into the liquid lumen, usually in the second section located at or towards the apparatus exit. It also means that mixing of liquid and gas is happening in the very turbulent and gas-rich space that is the gas lumen, aiding more efficient nanobubble formation and resulting in smaller nanobubbles.

Apparatus of the present invention may therefore be uni-directional, wherein gas passes through into the liquid lumen along the whole length of the apparatus and the mixing of liquid and gas takes place in the liquid lumen. Alternatively, apparatus of the present invention may be bi-directional, wherein liquid passes into the gas lumen in a first section, mixing of liquid and gas takes place in the gas lumen and liquid and gas then together pass back through into the liquid lumen in a second section. It will be appreciated that only a relatively small proportion of liquid passes into the gas lumen, depending upon pressure differential at that point. The bi-directional design requires less careful alignment between the water and gas pressures and allows for efficient nanobubble formation across a broader range of conditions (e.g. pressures). In order words, the bi-directional design may not require the relative pressures to be quite so carefully monitored and controlled, provided gas lumen pressure is higher than liquid lumen pressure towards the exit of the apparatus. Methods of the invention may comprise operating the apparatus so that liquid passes into the gas lumen in a first section, at or towards entry into the apparatus of liquid, along the length of the apparatus the gas pressure in the gas lumen rises and the liquid pressure in the liquid lumen falls, and liquid and gas then pass into the liquid lumen in a second section at or towards exit of liquid from the apparatus.

An interior surface of the liquid lumen suitably comprises one or more vanes or blades to promote turbulent flow of liquid therein. Nanobubble formation is improved as a result. The vanes or blades may be provided on an inside of the sidewall, i.e. projecting from its inner surface into the liquid flowing in the lumen. Vanes/blades are preferably helical, being formed of or comprising helical vanes or blades. Preferably, the vanes or blades project or protrude further into the liquid lumen at a second end of the liquid lumen, closest to the liquid outlet, than at a first end, closest to the liquid inlet. The extent of projection of the one or more vanes into the liquid lumen may increase along the length of the lumen in the direction of liquid flow. In an example of the invention, described below, the vanes/blades extend along a portion of the length of the lumen and project substantially to the same extent from the inner surface of the lumen hence, as the cross-sectional diameter of the liquid lumen decreases in the direction of flow from the liquid inlet to the liquid outlet so the vanes project more into the lumen and closer to the lumen centre. An example below shows this in one embodiment.

In preferred embodiments of the invention, the cross-sectional diameter of the liquid lumen, and hence its area, decreases in the direction of flow from the liquid inlet to the liquid outlet. The decrease in area is generally at least 10% along the length of the lumen, typically at least 25%. The decrease can be 40%, or 50% or more. This narrowing of the liquid lumen is found advantageous as it promotes forming of a vortex and supports cavitation, improving creation of nanobubbles.

The liquid lumen is preferably substantially circular in cross section.

The liquid and gas lumens can run alongside each other, sharing at least one common sidewall. Preferably, the one or more sidewalls are of substantially constant thickness along the length of the apparatus, i.e. the thickness of the one or more sidewalls stays the same from the first end to the second end of the apparatus. The liquid lumen is preferably disposed within the gas lumen. In this arrangement the gas permeable material forming the liquid lumen is preferably surrounded by gas within the gas lumen. The gas lumen may as a result be substantially toroidal, and positioned around the liquid lumen. As also described in an example below, the tube forming the liquid lumen is preferably composed substantially entirely of the gas-permeable material.

In a preferred embodiment, shown below, the apparatus comprises a central tube forming the liquid lumen, being substantially circular in cross section and located centrally within a substantially circular cross section housing, which forms the gas lumen between an inner surface of the housing and an outer surface of the tube. The housing and tube are preferably substantially concentric with each other.

The cross-sectional area of the gas lumen may also increase in the direction of flow from the liquid inlet to the liquid outlet. The increase in area is generally at least 10% along the length of the lumen, typically at least 25%. The increase can be 40%, or 50% or more. With the lumen formed by an inner tube disposed within the housing, and the housing being approximately cylindrical it is appreciated that with the inner tube (i.e. the liquid lumen sidewall) of substantially constant thickness the gas lumen area increases as the liquid lumen area decreases.

Preferred apparatus have one or more gas inlets but no gas outlet. Particularly preferred apparatus have one gas inlet and no gas outlet. The gas lumen can easily be pressurized in use, suitably to a pressure of between 3 psi (20.7 kPa) and 300 psi (2,068 kPa).

Further the gas inlet(s) is preferably located at or near the liquid inlet end of the apparatus. At this end the gas lumen cross-sectional area is, as described above, preferably reduced compared to its area at the apparatus outlet end.

Within the gas lumen one or more vanes or blades can also be provided, to promote turbulent gas flow. The one or more vanes or blades can be located on an inner surface of a housing forming the gas lumen sidewall; they are preferably located on an outer surface of the sidewall of the liquid lumen, thus more preferably on an outer surface of the tube forming the central liquid lumen. Preferably, the one or more vanes in the gas lumen direct gas in a helical flow pattern and in the opposite direction to the helical flow in the liquid lumen.

Liquid entering the liquid lumen does so via the liquid inlet. This may be angled, or may comprise a nozzle that is angled, with respect to a longitudinal axis of the lumen (typically the lumen is defined by a straight tube and the axis runs along the central, longitudinal tube axis) to promote turbulent flow of liquid therein. Suitable angles are from 45 degrees to orthogonal to the longitudinal axis. Introducing liquid at an angle can enhance the helical flow pattern of and turbulence in the liquid as a result of the vanes/blades described above (when present).

Optionally, gas bubbles may be introduced directly into the liquid lumen through the liquid inlet or some other upstream element which delivers gas bubbles directly into the liquid lumen. Typically, a small amount of gas is introduced directly into the liquid lumen when the pressure in the liquid lumen is higher, or preferably a lot higher, than the pressure in the gas lumen at the first end (i.e. entrance end) of the apparatus. In this case, it may be said that the liquid entering the liquid lumen is infused with gas and as the liquid passes through the apparatus the infused gas is converted into nanobubbles or, in other words, the gas bubbles in the liquid are broken down into nanobubbles.

Similarly, when the pressures are operated such that the pressure difference between the gas and liquid lumens is suitable, a small amount of liquid may be introduced directly into the gas lumen at the first end (i.e. entrance end) of the apparatus, either through the one or more gas inlets or through another element configured to inject liquid into the gas lumen. Typically, a small amount of liquid is introduced directly into the gas lumen when the pressure difference between the liquid lumen and the gas lumen at the first end (i.e. entrance end) is not as high. For example, when the pressure of the liquid in the liquid lumen is the same as the pressure of the gas in the gas lumen at the first end, some liquid may be injected directly into the gas lumen to increase the pressure difference and promote the movement of gas (and some liquid) into the liquid lumen.

Apparatus of particular embodiments comprise, or further comprise, one or more magnets to promote nanobubble formation. One or more sidewalls of the liquid lumen may comprise one or more magnets located or otherwise incorporated therein. Magnets are optionally located in the sidewall(s) and/or with vanes/blades projecting into the liquid lumen. The apparatus may include a pair of opposed magnets or a plurality of pairs of magnets. In use of apparatus including the magnets, nanobubbles of increased stability have been obtained.

Preferably a plurality of magnets are provided, each interspersed substantially evenly around the circumference of the tube forming the liquid lumen, the magnets suitably being embedded into the sidewalls/vanes and close to or adjoining the tube inner surface or vane surface. The number and circumferential distribution depends to some extent upon the respective magnet and tube sizes.

The magnets may be orientated with common poles all facing the lumen centre. Thus, all N poles may face the centre or all S poles may face the centre. It is preferred to provide one set of magnets with all N poles facing the centre and a second set of magnets spaced longitudinally along the tube from the first set with all S poles facing the centre. This arrangement has been found to promote nanobubble formation and stability. It is further preferred to provide, additionally, a third set of magnets, with half of the N poles facing the centre and half of the S poles facing the centre, like poles preferably adjacent each other.

Permanent magnets, e.g. neodymium magnets, can be used. Generally the magnets have approximately rectangular shape(s). They are interspersed in the material of the porous side wall and suitably present at 5-30%, preferably 6-15% of the total weight of the gas-permeable nano-tubular member or inner tube, depending on the overall size and performance requirement of the element. In specific embodiments, there are a plurality of magnets arranged evenly around the circumference of the inner tube with the aim of producing polarized areas in and around the nanobubble generator.

It is found that the repulsive magnetic field generated by the S (or N) pole of the static magnets help create negative ions which further enhance the solubility of the nanobubbles.

Nanobubbles as referred to herein generally have diameters of 1 micron or less. In using the invention, it is possible reliably to make nanobubbles of diameter of 1 micron or less, or 500 nm or less, or preferably 400 nm or less, for example in the range 10 400 nm. Nanobubbles of diameter 300 nm or less can be made, for example in the size range 75-200 nm. In specific examples, nanobubble-containing compositions have been made predominantly containing nanobubbles of diameter 100 nm or less.

The size of the nanobubbles may be measured directly using a Malvern laser diffraction machine. Alternatively, nanobubble size or at least effectiveness of nanobubble production may be approximated by measuring the dissolved oxygen content of the liquid. Typical values measured for the apparatus of the present invention are a dissolved oxygen content of around 6 ppm (6 DO₂) for the liquid input and a dissolved oxygen content of around 40 ppm (40DO₂ ) for the liquid output (i.e. an increase of 34 ppm dissolved oxygen content is observed) in one pass through the apparatus.

Along the length of the liquid lumen its diameter optionally decreases. The apparatus is suitably adapted, and optionally the relative pressures are operated, so that there is a pressure differential between the gas in the gas lumen and liquid in the liquid lumen and the net effect is that the differential increases along the length of the apparatus in the direction of liquid flow. The differential drives nanobubble formation as gas is forced through the gas permeable material defining the liquid lumen.

The relative pressures of the gas in the gas lumen and the liquid in the liquid lumen are typically operated such that the pressure differential between the liquid in the liquid lumen and the gas in the gas lumen changes along the length of the apparatus. Typically, the pressure differential is optimized by careful control of the gas pressure. This is because it is typically more difficult to control the liquid pressure, so the liquid is pumped into the apparatus at constant pressure and the pressure of the gas is under constant control. Preferably, the relative pressures will be operated such that the pressure differential is greatest at the second end. Hence, it is preferred that the net effect is that the pressure differential increases along the length of the apparatus.

The liquid in the liquid lumen may be at lower pressure than the gas in the gas lumen along the whole length of the apparatus. The pressure differential may increase from the first end to the second end, resulting in the gas being at significantly greater pressure at the second end and causing the gas to move into the liquid lumen. Alternatively, the liquid in the liquid lumen may be at the same or higher pressure than the gas in the gas lumen at a first end and at a lower pressure than the gas in the gas lumen at the second end. Optionally, when the liquid in the liquid lumen is at the same or higher pressure than the gas in the gas lumen at the first end, some liquid may leak or bleed into the gas lumen. As a result of the large pressure differential at the second end, any leaked liquid is returned to the liquid lumen at the second end, along with gas from the gas lumen; this effect is a result of the combination of both gas and liquid pressures in the gas lumen compared with lower pressure in the liquid lumen at or towards the second end (exit).

The pressure differential between the liquid in the liquid lumen and the gas in the gas lumen may optionally be further increased by introduction of liquid into the gas lumen. This increases the pressure in the gas lumen, thus forcing liquid and gas into the liquid lumen and promoting nanobubble formation.

The gas permeable material can withstand a great range of pressures. In general, the apparatus operates with a balance between gas pressure and liquid pressure, adjusted so there is net flow of gas into the liquid (and not the other way). As an example, for gas flow at atmospheric pressures with no direct gas pumping assistance, liquid pressure at 2-3 bar can be used. The apparatus can also work, though sometimes less efficiently, at lower liquid pressures, for example 0.5 bar liquid pressure and no gas pumping assistance. At lower pressure, an option is to use apparatus having a lengthened inner tube, to increase the contact area between the liquid and the incoming gas. In other setups, the apparatus can be operated with lower liquid pressure and higher gas pressure, such as 0.5 bar liquid pressure and 2 or more bar gas pressure. This arrangement allows use of a relatively shorter inner tube at high gas flow rate.

In embodiments of the invention the surface roughness of the outer surface of the sidewall(s) of the liquid lumen and/or also its inner walls have roughness within certain parameters to promote nanobubble formation. It is preferred that the inner surface of the sidewall(s) of the liquid lumen—in embodiments, the inner surface of the tube forming the lumen—has a surface roughness of Ra 4-40 μm, more preferably Ra 8-20 μm. This surface property of the gas permeable material is found to increase micro-turbulence and micro-cavitation at the shearing layer for gas entering the liquid, increasing mixing of gas into the liquid. It is separately preferred that roughness of the outer surface of the sidewall(s) of the liquid lumen—in embodiments, the outer surface of the tube forming the lumen, i.e. on the gas side—has a surface roughness of Ra 15-90 μm, more preferably Ra 30-65 μm, promoting gas turbulence in the gas lumen. The roughness of the material creates beneficial cavitation and turbulence effects, both in the internal liquid lumen and the external gas lumen.

In specific embodiments of the invention, illustrated in an example herein, the inner tube is substantially circular in cross section, the housing is substantially circular in cross section and the inner tube is mounted substantially centrally and concentrically within the housing.

In further specific embodiments of the invention, illustrated in an example herein, the inner tube is substantially circular in cross section, the housing is substantially circular in cross section, the inner tube is mounted substantially centrally and concentrically within the housing, helical vanes are provided on the inner surface of the inner tube and magnets are included in the inner tube sidewall(s) and/or in the vanes.

Also provided by the invention is a method of making nanobubbles, comprising
introducing liquid into a liquid lumen, said lumen defined by one or more sidewalls, a liquid inlet and a liquid outlet, the one or more sidewalls being made of or comprising gas-permeable material;
introducing gas into a gas lumen, said lumen defined by the one or more sidewalls of the liquid lumen, one or more further sidewalls, one or more gas inlets and, optionally, a gas outlet, so that the gas introduced into the gas lumen passes through the gas-permeable material and into the liquid, forming nanobubbles; and
decreasing the pressure of the liquid as it flows along the length of the liquid lumen.

In use nanobubbles are efficiently made using this method. In the method, the cross-sectional diameter of the liquid lumen preferably decreases in the direction of flow from the liquid inlet to the liquid outlet.

The method may comprise providing one or more magnets, or preferably an arrangement of magnets, in the sidewalls of the liquid lumen to promote nanobubble formation.

Further methods of the invention preferably are carried out using apparatus according to the invention, optionally incorporating one or more or all preferred aspects thereof.

The invention thus provides apparatus that offers an effective and efficient method to produce an activated liquid medium filled with nanobubbles, and methods to use such generator and activated liquid.

Specific uses of liquids containing nanobubbles according to the invention include cleaning membranes (a scouring/cleaning effect is achieved when the nanobubbles burst), decreasing water tension in agriculture (negative charges on the nanobubbles promote better filtration of water through the soil), increasing dissolved oxygen content in water for healthy growth of fish, delivering hydrogen into fuel for more efficient fuel consumption, deoxygenation of water (by pumping air, nitrogen or nanobubbles of other inert gas into the water) and also introducing hypochlorous acid or carbon dioxide into water.

Nanobubble-containing compositions of the invention can be used for
purification of liquid in polluted seas, lakes and marshes, dams, rivers etc.;
purification of drinking water, industrial water, agricultural water, aquicultural water, cooling water;
purification of waste oil discharged from factories and gas stations etc.; cleaning and sterilisation of food, agricultural and aquicultural products, medical treatments;
extinguishing of undesirable bubbles;
preservation of freshness of food;
storage of gas (such as hydrogen, carbon dioxide, methane etc.) in liquid
improvement of fire-fighting equipment by the infusion of nanobubbles, including CO₂ nanobubbles;
affecting the temperature and pH of water by using nanobubbles;
improving the homogenization of materials in liquids; and
assisting in the transport of fish without the use of chemicals, by adapting the composition of the carrier water using nanobubbles.

Nano-bubbles of the invention can also be used in carbonated drinking water.

One particularly useful water treatment application involves environmental water remediation. Because the nano-bubbles having a prolonged lifespan in water and significant mixing potential, compositions comprising the nanobubbles can be used to remediate the ecological balance of lakes, rivers, and the ocean. Enriching water bodies with an abundance of oxygen can help restore beneficial aerobic activity that works to breakdown sludge, hydrogen sulfide, environmental toxins, and pathogenic organisms. Other applications in water treatment include assisting in the remediation of heavy metals from water.

The compositions of the invention can be used as, or combined with a further liquid to create, a pumpable composition to improve the viscosity of a liquid, thereby facilitating its transport or giving the liquid particular characteristics, for example crude oil and drilling fluids, as well as others, and then transporting the pumpable composition through a pipe to a desired destination.

Nano-bubbles of the invention can be used for sterilization, e.g. an application involves using the compositions containing nano-bubbles in a liquid carrier for sterilization purposes. In this use. as the nano-bubbles collapse, oxygen is activated in the air and forms molecules such as O and OH—. These molecules are potent sterilizers that can be used to destroy pathogenic organisms and certain volatile organic compounds.

Nano-bubbles of the invention have been found by the inventors to be stable in the liquid carrier, suitable to be transported for long distances without dissolving or coalescing in the liquid carrier. The concentration of nano-bubbles in the liquid composition can be high, using the apparatus of the invention, and hence the nano-bubbles are an efficient source for transporting gas to a desired source. In addition, with a smaller surface area and high solubility, compositions containing nano-bubbles are many times more efficient at transferring gases such as oxygen into liquid compared to conventional aeration. The invention has successfully been used to produce nanobubbles which have a mean diameter of approximately 100 nm and which remain dispersed in the liquid carrier for one or more months in a stable state under ambient temperature and pressure.

### EXAMPLES

The present invention is now described in more specific detail with reference to the accompanying drawings, in which:

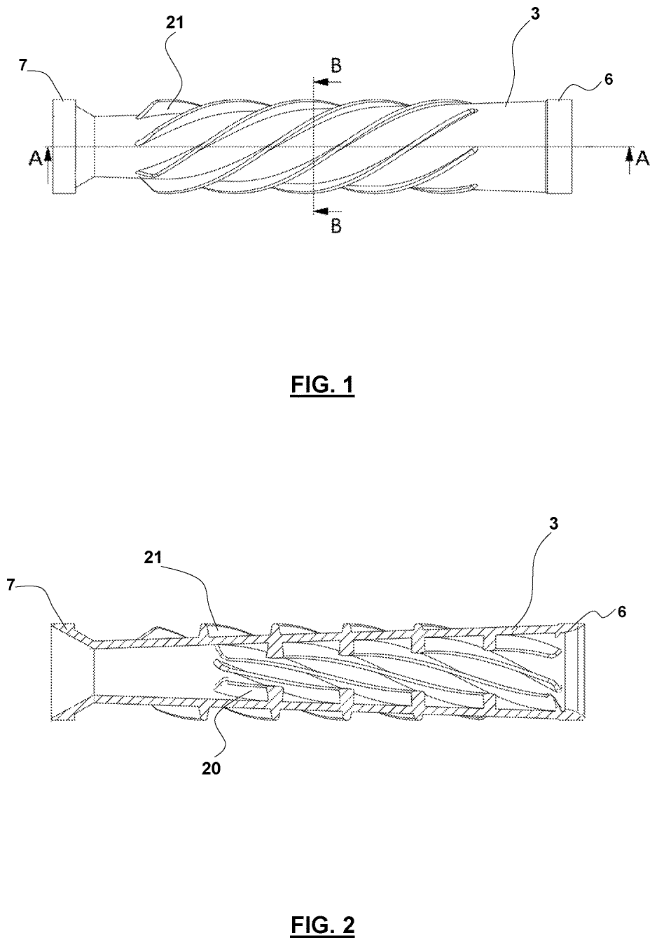

FIG. 1 shows a side view of a porous central tube of an apparatus of the invention;

FIG. 2 shows a cross-sectional view along the dotted line A-A shown in FIG. 1 of the tube;

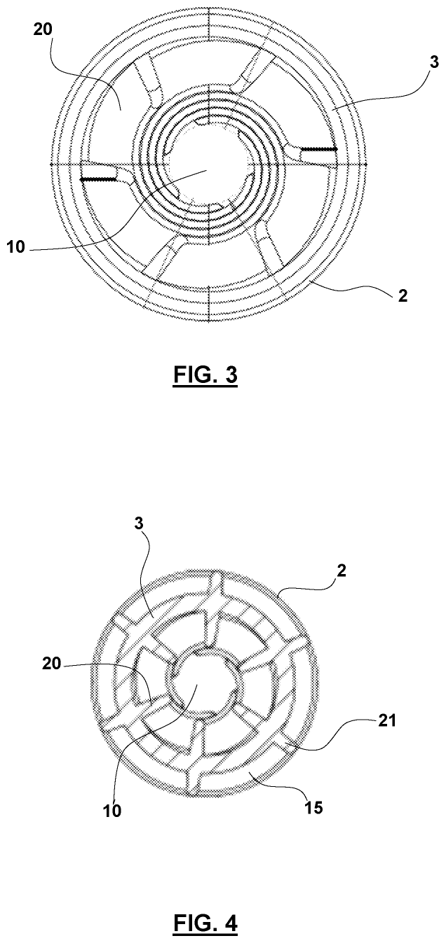

FIG. 3 shows an end view of the tube of FIG. 1, viewed from the right hand side of FIG. 1;

FIG. 4 shows a cross-sectional view along the dotted line B-B shown in FIG. 1 of the tube;

FIG. 5 shows a photograph of a housing of an apparatus of the invention;

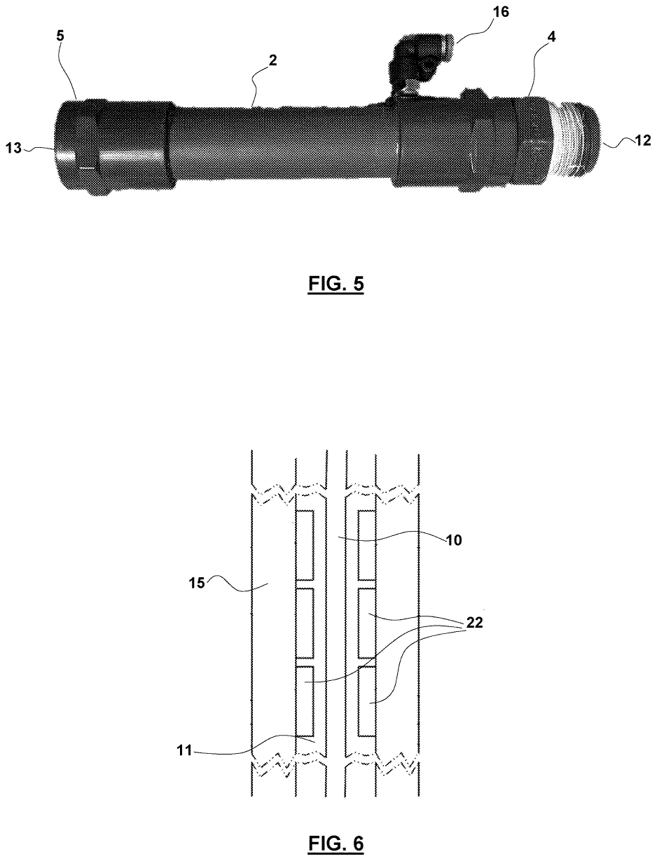

FIG. 6 shows a schematic side view of a porous central tube inside a housing of an apparatus of the invention; and

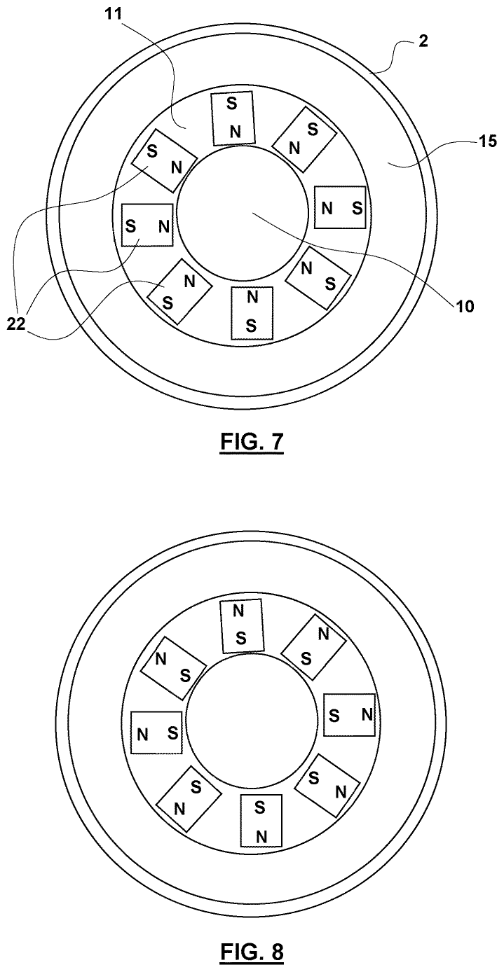

FIGS. 7 to 9 show schematic end views of the apparatus of FIG. 6.

FIG. 10 shows a schematic cross-sectional view along the dotted line A-A shown in FIG. 1 of an apparatus of the invention.

### Example 1

Referring to the figures, there is generally shown a nanobubble making apparatus (1) having a housing (2) in the form of a hollow tube, an elongate inner porous tube (3) installed within the housing component (2) and ends (4, 5) that connect to and seal to input and output tubing (not shown).

The components of the apparatus (1) are arranged such that both ends of the inner component (3) align with the ends of the housing component (2) and each end (4, 5) are fixedly connected to either end of the housing component (2).

The central tube (3) comprises an inner lumen (10) which is configured in use to receive flowing liquid from input tubing (not shown) connected to the first, input end (4) and a porous side wall (11) which is configured to allow diffusion of gas from an outer lumen (described below) through the wall and into the inner lumen (10). The liquid enters the lumen (10) through a liquid inlet (12) in the first end (4) and exits the lumen (10) through a liquid outlet (13) in the second end (5). The tube (3) is in the form of a hollow truncated cone, such that the lumen (10) is wider at the first, liquid entry end and narrower at the second, liquid exit end. The porous side wall (11) comprises gas permeable material sized so that nanobubbles form in use as gas passes through the tube wall and into the liquid flowing in the lumen. The tube can be made entirely of the gas permeable material.

The tube is mounted within a cylindrical housing (2) of greater diameter than the tube and has ends (6,7) in the form of circular rings that are sealed to corresponding annular sealing surfaces at the respective ends of the housing, forming an outer lumen (15). The central portion of the housing, corresponding to the length of the central tube, sealingly enclosed therein, is of constant diameter and cross section. As can be seen, both the housing and central tube are circular in cross section, and concentric-the tube being inside the housing.

The outer lumen, being the gap between the outer surface of the tube (3) and the inner surface of the housing (2) thus provides an elongated toroidal gas cavity (15). The gas cavity (15) is sealed and has a single gas inlet (16). Due to the conical shape of the outer surface of the tube (3), narrowing towards the exit end (5), and the constant cross-section of the housing the gap between the outer surface of the tube and the inner surface of the housing is narrower at the first end and wider at the second end, such that, in the direction of flow of liquid in use, the gas cavity (15) widens as the lumen (10) narrows. The gas inlet (16) is located near the same end as the liquid inlet (12), such that the liquid and gas flow in the same direction through the apparatus.

During manufacture of nanobubbles liquid flows through the lumen (10) from the input end to the exit end while the gas cavity (15) is filled with pressurized gas. In use the pressurized gas in the gas cavity (15) passes through the gas-permeable, porous side wall (11) which allows the gas to diffuse into the stream of liquid in the lumen (10) and subsequently be incorporated into the liquid in the form of nanobubbles.

Formation of nanobubbles, as the gas passes through the porous side wall (11), is enhanced as a result of the Venturi effect. Without wishing to be constrained by the theory, the Venturi effect is the reduction of pressure in a fluid that occurs when the fluid flows into a more constricted/narrower section of a tube. It is understood that the pressure of the liquid decreases as it flows through the lumen (10) from the first end (wider) to the second end (narrower), meanwhile the gas in the gas cavity (15) is under pressure, more or less constant throughout the cavity, or rising towards the exit, which results in an increased pressure differential towards and at the second end, where the lumen is narrower. More gas is then in effect sucked from the pressurized gas cavity (15), across the porous side wall and into the lumen (10) near the second end, since the local difference in pressures between the liquid in the lumen (10) and the gas in the gas cavity (15) is greatest at this end. Apparatus of the invention are suitably adapted and can be operated such that the pressure of gas in the gas lumen increases in the direction of flow and the pressure of liquid in the liquid lumen decreases in the direction of liquid flow.

The porous side wall (11) has a mean pore size of 100 nm and the apparatus is configured to receive gas in the outer lumen or gas cavity pressurized to between 5 psi and 100 psi.

The tube (3) is provided with two set of helical vanes (20, 21), one on its inner surface, in contact with liquid flowing through the tube and one on its and outer surface, i.e. on the gas side. The set of helical vanes on the inner surface (20) turn in the opposite direction to the helical vanes on the outer surface (21). There is also a set of magnets (22) embedded within the tube wall (see FIGS. 6 to 9. The vanes (20) on the inner tube surface function to force liquid into a helical flow pattern and increase turbulent flow in the internal cavity (10). This promotes nanobubble formation of desired size and helps ensure that the thus activated liquid is carried away quickly and prevent the nanobubbles from coalescing into larger bubbles. The vanes on the outer surface (21) function similarly to further increase turbulence on the gas side as well as to guide the flow of gas over the porous side wall (11) in the form of a vortex. The vanes are arranged in a spiral pattern, such that the area between the vanes narrows down the length of the device (i.e. the area between the vanes is smaller near the liquid outlet (13) than it is near the liquid inlet (12)).

In addition, magnets in the apparatus provide a magnetic field to promote the generation of nanobubbles within the liquid. The magnetic field is generated by a plurality of magnets (22) positioned within the porous side wall (11). The magnets (22) are permanent neodymium magnets of varying strengths, aligned in a perpendicular arrangement to the direction of flow of liquid through the lumen (10), such that a first pole of each magnet (22) faces the centre of the lumen (10) and a second pole faces the gas cavity (15). Note that FIGS. 6 to 9 schematically show a cross section of a simplified apparatus of the invention, with no helical vanes, not to scale but illustrating location of and orientation of the magnets.

3 sets of magnets (22) are evenly spaced around the internal circumference of the porous side wall (11) as shown in FIGS. 7 to 9 (sets of 8 magnets are shown schematically in the figures as an example of a typically arrangement, however in practice there may be more or less than 8); the 3 sets are located in a middle region of the tube, i.e. only in the portion of the apparatus with vanes both on the outer and inner surfaces of the tube (see e.g. FIG. 2). There are therefore no magnets (22) present at either end of the apparatus near the liquid inlet (12) or liquid outlet (13).

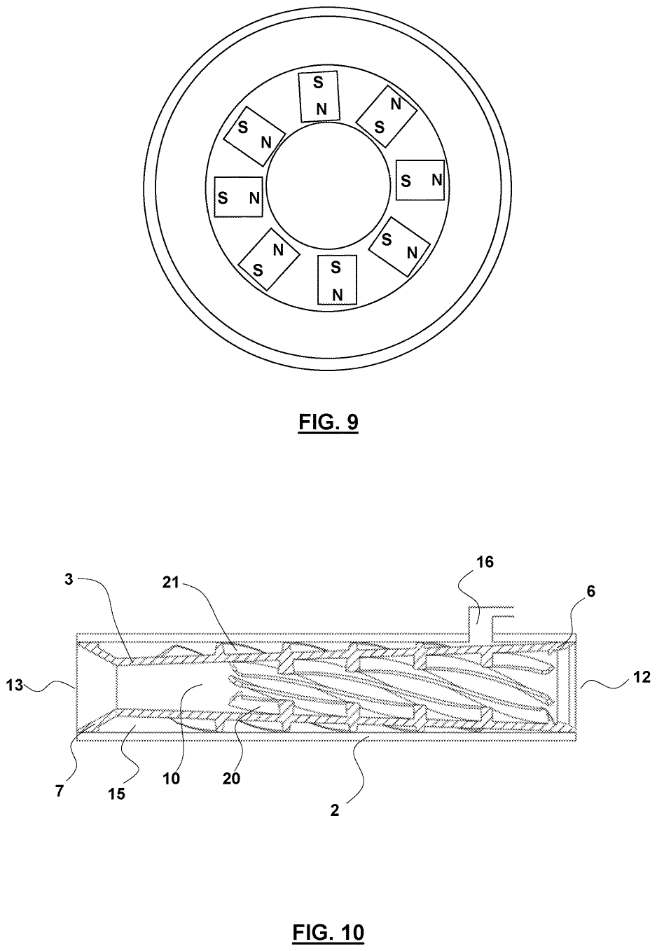

There are three distinct sections of magnets (22) along the length of the apparatus, wherein the magnets (22) are arranged differently in each section. Each section is of equal length, with the first section being closest to the end of the apparatus which comprises the liquid inlet (12) and the third section being closest to the end of the apparatus which comprises the liquid outlet (13). In the first section, the magnets (22) are arranged such that only the N poles face towards the centre of the lumen (10), as shown in FIG. 7. In the second section, they are arranged so that only the S poles face towards the centre of the lumen (10), as shown in FIG. 8, and in the third and final section the magnets (22) are arranged such that the N poles face towards the centre of the lumen (10) on one side of the porous side wall (11) and the S poles face towards the centre of the lumen (10) on the opposite side of the porous side wall (11), as shown in FIG. 9. The three separate sections of magnets are aligned in this manner by using a plurality of larger magnets to generate a magnetic field in the inner (liquid) lumen.

In the sections where the magnets (22) are arranged such that common poles face inwards (i.e. in the first and second section) the magnetic force lines align such that certain forces are repulsive and other are attractive, this creates a strong electromagnetic field between opposite sides of the porous side wall (11). With the help of the vortex created by the vanes, this promotes the mixture of liquid and gas. In the third section where the magnets (22) are arranged such that opposite poles face inwards, the electromagnetic field acts to increase the amount of nanobubbles. Specifically, the repulsive magnetic fields generated by the S or N poles help create negative ions which further enhance the stability of the ultrafine bubbles.

The effect of the first and second sections of polarizing magnetic areas is to create chaotic electromagnetic environments in the vortex flow of nanobubbles, while the third section smooths out the electromagnetic environment; as a result of managing these effects, the Zeta potential and antiseptic effects of the nanobubbles in the water flow are influenced/controlled.

Additionally, both the inner and outer surface of the tube (3) have rough surfaces. The inner surface bears a roughness of Ra 30-65 μm while the roughness of the outer surface is Ra 8-20 μm. The roughness of the inner surface creates cavitative action in the liquid which helps promote formation of nanobubbles, while the roughness of the outer surface further increases gas turbulence in the gas cavity (15).

The liquid composition made by the apparatus, containing nanobubbles, is termed an activated liquid and the nanobubbles produced by the apparatus have a diameter of 100 nm or less. The apparatus can produce a concentration of nanobubbles in the resulting activate liquid of at least 1×10⁶ nanobubbles/ml and the nanobubbles are stable in the solution at ambient temperature and pressure; therefore, this concentration can remain constant for a month or more.

### Example 2

An apparatus of the present invention was tested at a liquid input flow rate of 42 m³/hr, with a water pressure of 0.2 bar (2.9 psi) at the water inlet, 0.25 bar (3.62 psi) at the water outlet and a gas pressure of 0.45 bar (6.5 psi). The gas throughput result (i.e. a measure of gas or nanobubbles in the output) was measured as 30 lpm (litres per minute).

A commercially available apparatus for making nanobubbles, by way of comparison, works at a liquid flow rate of 90-125 m³/hr, with a maximum water pressure of 1.5 bar (21.75 psi) and a gas flow rate was 0 -40 lpm, with a maximum gas pressure of 8 bar (116 psi). The gas throughput result achieved by this apparatus is somewhere in the region of 0 -40 lpm.

Hence, the gas throughput result achieved by the apparatus of the present invention is at the top end of the range of results achieved by the known apparatus even though the apparatus of the present invention works at around one third of the water flow rate, one seventh the water pressure and one sixteenth of the gas pressure.

It is therefore clear from these results that the apparatus of the present invention can be more efficient at producing nanobubbles at much lower water and gas pressures, than existing apparatus disclosed in the prior art.

### PARTS LIST

1 apparatus
2 housing
3 central tube
4 first, inlet end
5 second, exit end
6,7 outer ring ends of the tube
10 lumen of tube, liquid cavity
15 outer lumen between tube and housing, gas cavity
16 gas inlet
11 porous side wall
12 liquid Inlet
13 liquid outlet
20 helical vanes on inner surface of tube
21 helical vanes on outer surface of tube
22 magnets

1. An apparatus for making nanobubbles, comprising:
a liquid lumen through which liquid flows in use, defined by one or more sidewalls, a liquid inlet and a liquid outlet, the one or more sidewalls being made of or comprising gas-permeable material;
a gas lumen though which or into which gas flows in use, defined by the one or more sidewalls of the liquid lumen, one or more further sidewalls, a gas inlet and, optionally, a gas outlet;
wherein in use gas introduced into the gas lumen passes through the gas-permeable material of the one or more sidewalls and into liquid flowing in the liquid lumen as nanobubbles; and
wherein the cross-sectional diameter of the liquid lumen decreases in the direction of flow from the liquid inlet to the liquid outlet.

2. The apparatus of claim 1, wherein an interior surface of the liquid lumen comprises one or more vanes to promote turbulent flow of liquid therein.

3. The apparatus of claim 2, wherein the extent of projection of the one or more vanes into the liquid lumen increases along the length of the lumen in the direction of liquid flow.

4. The apparatus of claim 1, wherein the exterior surface of the liquid lumen comprises one or more vanes.

5. The apparatus of claim 1, wherein the liquid lumen is substantially circular in cross section.

6. The apparatus of claim 1, wherein the liquid lumen is disposed within the gas lumen.

7. The apparatus of claim 1, wherein the cross-sectional diameter of the gas lumen increases in the direction of flow from the liquid inlet to the liquid outlet.

8. The apparatus of claim 1, wherein the liquid inlet is angled with respect to a longitudinal axis of the lumen to promote turbulent flow of liquid therein.

9. The apparatus of claim 1, wherein the one or more sidewalls of the liquid lumen comprise one or more magnets.

10. The apparatus of claim 1, wherein the one or more sidewalls of the liquid lumen are of substantially constant thickness along the length of the apparatus.

11. The apparatus of claim 1, for making nanobubbles of mean diameter <400 nm.

12. The apparatus of claim 1, adapted so that there is a pressure differential between the gas in the gas lumen and liquid in the liquid lumen and the differential increases along the length of the apparatus in the direction of liquid flow.

13. The apparatus of claim 1, adapted so that the pressure of gas in the gas lumen increases in the direction of flow and/or the pressure of liquid in the liquid lumen decreases in the direction of liquid flow.

14. The apparatus of claim 12, wherein the pressure differential between gas in the gas lumen and liquid in the liquid lumen is greatest at an end of the apparatus which is closest to the liquid output.

15. The apparatus of claim 1, wherein the gas permeable material of the inner tube has a surface roughness of Ra 4-40 μm, preferably Ra 8-20 μm.

16. The apparatus of claim 1, wherein the inner tube is substantially circular in cross section, the housing is substantially circular in cross section and the inner tube is mounted substantially centrally and concentrically within the housing.

17. A method of making nanobubbles, comprising
introducing liquid into a liquid lumen, said lumen defined by one or more sidewalls, a liquid inlet and a liquid outlet, the one or more sidewalls being made of or comprising gas-permeable material;
introducing gas into a gas lumen, said lumen defined by the one or more sidewalls of the liquid lumen, one or more further sidewalls, a gas inlet and, optionally, a gas outlet, so that the gas introduced into the gas lumen passes through the gas-permeable material and into the liquid, forming nanobubbles; and
decreasing the pressure of the liquid as it flows along the length of the liquid lumen.

18. The method of to claim 17, wherein the apparatus comprises a first end, closest to the liquid inlet and a second end, closest to the liquid outlet, and wherein the method further comprises liquid passing through the gas-permeable material from the liquid lumen into the gas lumen at the first end and liquid passing back through the gas-permeable membrane back into the liquid lumen at the second end.

19. The method of claim 17 wherein the method further comprises operating the pressure of the gas in the gas lumen and/or the liquid in the liquid lumen such that the pressure differential between the liquid in the liquid lumen and the gas in the gas lumen changes along the length of the apparatus in the direction of liquid flow.

20. The method of claim 19 wherein the pressure differential is greatest at the second end of the apparatus.

21. The method of claim 17, wherein the cross-sectional diameter of the liquid lumen decreases in the direction of flow from the liquid inlet to the liquid outlet.

22. The method of claim 17, comprising providing one or magnets in the sidewalls of the liquid lumen to promote nanobubble formation

23. (canceled)
